(19) United States
(12) Patent Application Publication
(10) Pub. No.: US 2003/0084458 A1
(43) Pub. Date: May 1, 2003

(54) Local network forming part of a cable tv system

(76) Inventors: Kjell Arne Ljungdahl, Saltsjo-boo (SE); Bo Peter Cullblom, Lidingo (SE); Lars Ake Peter Carlsson, Saltsjo-Boo (SE)

Correspondence Address: CROWELL & MORING LLP, INTELLECTUAL PROPERTY GROUP, P.O. BOX 14300, WASHINGTON, DC, 20044-4300, US

(21) Appl. No.: 10/149,382

(22) PCT Filed: Dec. 14, 2000
(86) PCT No.: PCT/SE00/02529

(30) Foreign Application Priority Data
Dec. 14, 1999 (SE) 9904589-0

(51) Int. Cl. H04N 7/16; H04N 7/18; H04N 7/173

(52) U.S. Cl. 725/124; 725/78; 725/80; 725/105; 725/25

(57) ABSTRACT

A local network (10), forming part of a cable TV system, includes subscriber outlets (21), from which signals can be transmitted in the return direction to a head end (11) of the system within a predetermined carrier frequency band. The network (10) is provided with a noise reduction unit (23) comprising an input (24), connected to the subscriber outlets (21), an output (27), connected to the head end (11), a plurality of band-pass filters (28-31), connected to said input (24) and having mutually different pass bands lying within said carrier frequency band, and a corresponding plurality of detectors (32-35), which are arranged each to compare the energy level of the output signal from one of said filters (28-31) with at least one predetermined reference level and to deliver logic signals depending upon the result of said comparison to a logic control unit (36), which is arranged to determined whether these signals satisfy certain conditions stored in the control unit (36) and to deliver a control signal, depending hereupon, to a controllable blocking circuit (26), which is connected in a separate line (25), serving to transmit signals from said input (24) to said output (27), and which is arranged to permit signals to pass therethrough only when it receives a control signal from the control unit (36), indicating that the logic signals received by the control unit (36) satisfy the conditions stored in said unit.

The present invention relates to a local network forming part of a cable TV system.

More particularly, the invention relates to such a local network of the kind which is arranged to permit a transmission of signals in the return direction from subscriber outlets included in said network to a head end of said system within a predetermined carrier frequency band, serving for the transmission of signals in said direction, and which is provided with a noise reduction unit, serving to reduce the amount of noise transmitted in the return direction from said network.

Local networks of said kind are utilized in cable TV systems which, besides for the distribution of TV and radio signals from the head end of the system to the subscribers connected to various local networks of the system, may be utilized also for bi-directional transmission of different kinds of signals between the subscribers and the head end of the system.

In such cable TV systems, within the carrier frequency band utilized for the transmission of signals in the return direction, there may occur severe disturbances due to noise generated in the local networks or entering into said networks through the subscriber outlets or the lines connected to said outlets and successively accumulated when passing through the system towards the head end. This is the reason why it-has been proposed to provide each local network wich a special noise reduction unit for reducing the amount of noise transmitted in the return direction from said network.

The invention relates to a local network which is provided with a noise reduction unit of the kind comprising an input connected to the subscriber outlets, an output connected to the head end, a plurality of band-pass filters connected to said input and having mutually different pass bands lying within said carrier frequency band, a corresponding plurality of detectors, which are connected each to one of said filters and which are arranged each to compare the energy level of the output signal from the respective filter with at least one predetermined reference level, and blocking means, operatively connected to said detectors and arranged to permit or prevent a transmission of signals from said input to said output in dependence upon the result of the comparison effected by said detectors. The expression “energy level” herein refers to the instantaneous energy content the filter output signal measured during short time intervals having a certain predetermined length.

A noise reduction unit of said kind is previously known through EP 0 859 514 A2, FIG. 7. In this known noise reduction unit, the blocking means are formed by separate blocking means for each individual pass band, each such blocking means being arranged to be controlled by the output signal from the detector belonging to the pass band in question. However, this design of the noise reduction unit is unfavourable for several reasons. Firstly, the different pass bands have to be placed at a certain distance from each other which, in turn, results in a poor exploitation of the total frequency band of the return channel. Furthermore, it does not make it possible in an easy manner at a later stage to shift or alter the use of the various pass bands so that they may be used for other services than those originally intended.

The invention has for its purpose to provide a local network provided with a noise reduction unit of the kind above specified and wherein the above disadvantages may be avoided or at least substantially reduced.

The network, according to the invention proposed for said purpose, is primarily characterized in that, for at least one group of adjacent pass bands, said blocking means are formed by a single blocking circuit which is common to all pass bands within said group and connected in a separate lint, serving for the transmission of signals within these pass bands from said input to said output, and which is operatively connected to each of the detectors belonging to said croup of pass bands.

As a consequence of the use of a single blocking circuit common to all pass bands within said group, the different pass bands within the around need no be placed at a certain distance from each other. Instead, said pass bands may be selected in a manner such that they wilt together cover the entire frequency range within which they are located. For this purpose, the different pass bands may be permitted to overlap each other slightly.

According to a preferred embodiment of the invention, said pass band group may suitably include all pass bands within the carrier frequency band serving for the transmission of signals in the return direction.

Furthermore, the detectors belonging to said group of pass bands may preferably be arranged to deliver logic output signals depending upon the result of the comparison effected by them to a logic control unit which is arranged to determine whether these signals satisfy certain conditions stored in the control unit and to deliver a control signal, depending hereupon, to the blocking circuit, in order hereby to bring this circuit to permit a transmission of signals from said input to said output only when said output signals from the detectors satisfy said conditions.

The conditions stored in the logic control unit may be of many different kinds. By way of example only, it could be mentioned that they may be such that, when the logic output signal from one detector received by the control unit is altered in a direction indicating that the output signal from the corresponding band-pass filter has just been changed from a value lower that said at least one reference level to a value exceeding said level, the control unit will deliver a control signal for permitting a signal transmission through the blocking circuit only on condition that the logic signals delivered from two or more of the other detectors are not simultaneous, altered in a corresponding manner.

The conditions stored in the control unit may consist of conditions peramently stored in said unit. However, with advantage, the control unit may instead be reprogrammable and arranged to permit an alteration of the conditions stored therein. In this case, the network may suitably be designed so as to make it possible to effect such a reprogramming of the control unit from the head end of the cable TV system.

According to a preferred embodiment of the invention, at least one and preferably each of the detectors belonging to said group of pass bands may be arranged to compare the energy level of the output signal from the band-pass filter connected thereto with at least two different reference levels. Such a detector function makes it possible to use the logic control unit to determine the slope of the front edge of the output signal from said band-pass filter and to ascertain whether it satisfies a corresponding condition stored in the control unit. Since the front edge of many kinds of disturbing signals emanating from outer sources has a slope which differs substantially from the slope of the front edge of a message signal transmitted from a subscriber outlet, the control unit may in this case suitably be arranged to deliver a control signal for permitting a signal transmission through the blocking circuit only on condition that the value of the determined slope falls within a predetermined permitted interval.

The abovementioned at least one reference level or each of the abovementioned at least two reference levels may have a fixed value. However, said level or each of said levels, respectively, may preferably be adjustable. For this purpose, said level or each of said levels, respectively, may suitably be generated by a reference level source controllable from the head end of the cable TV system.

In order, by means of the control unit, to determine whether an incoming signal at the input of the noise reduction unit is of such a nature that it should be permitted to pass through the blocking circuit, a certain time will inevitably be consumed, namely on the one hand the time it will take said signal to grow to a certain reference level and, on the other hand, the time required for carrying out the intended examination in the control unit. For this reason, it may be favourable, in the connection between the input of the noise reduction unit and the blocking circuit, to provide a delay means, in order hereby to prevent an initial portion of the message signal transmitted from a subscriber outlet from being cut away.

In order, after a change-over of the blocking circuit from its blocking state to its conductive state caused by a detection of a message signal at the input of the noise reduction unit by anyone of the detectors, to prevent the blocking circuit from being caused to return to its blocking state as a consequence of any modulation appearing on the message signal but only when said signal has in fact ceased to exist, each detector may be arranged, upon such a detection, not to change the output signal delivered to the logic control unit until a predetermined short time after the disappearance of the message signal in question.

Below the invention is further described with reference to the accompaying drawings, in which:

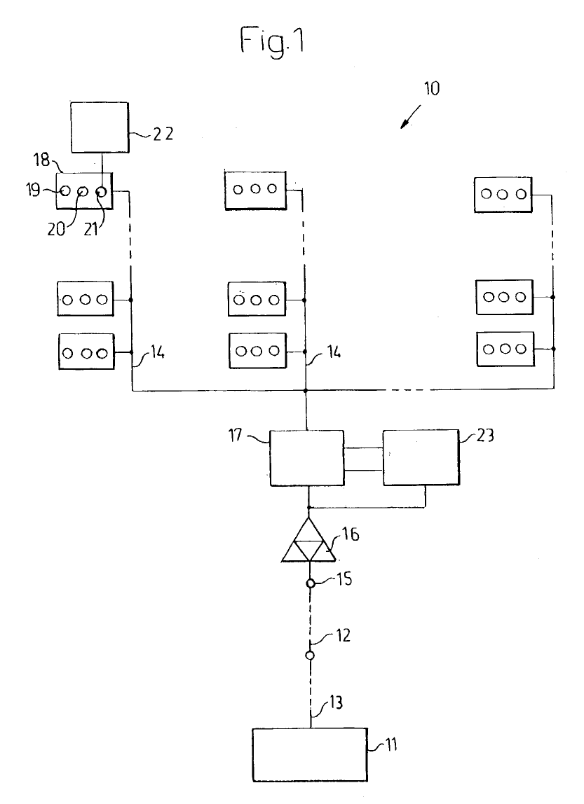

FIG. 1 shows a principle diagram of a local cable TV network according to an embodiment of the invention, selected by way of example only, and

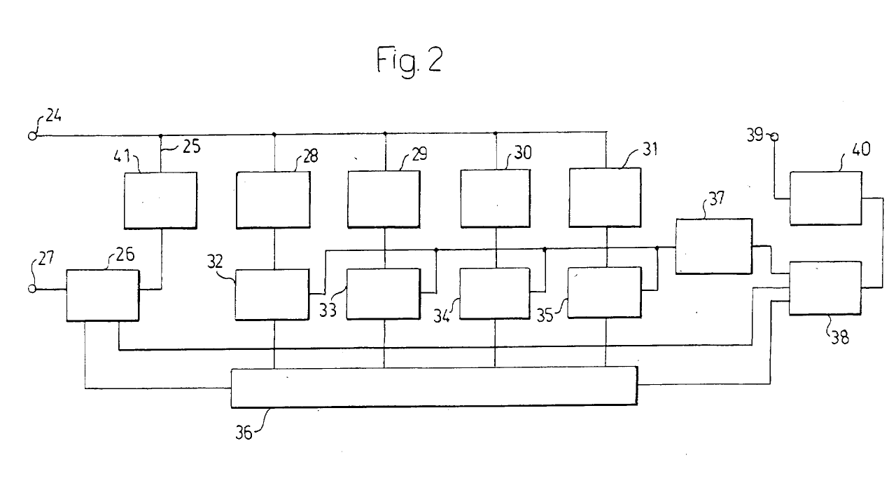

FIG. 2 shows a detailed block diagram of a noise reduction unit connected in said network and serving to reduce noise transmitted in the return direction from the network.

The cable TV network shown in FIG. 1 and generally designated 10 constitutes a local area network, forming part of a cable TV system, including a head end 11 which serves as a communication central and to which network 10 is connected via a diagramatically shown regional network 12 and a trunk network 13, also diagramatically shown and wherein head end 11 is provided.

Network 10 includes a plurality of branch lines 14 which, via a bi-directional amplifier 16 and a diplex filter 17, are connected to a combined input and output 15 of network 10 which, in its turn, is connected to network 12. Each branch line 14 is provided with a plurality of subscriber outlet boxes 18, each comprising three different outlets, namely a TV-antenna outlet 19, a radio-antenna outlet 20 and a data-terminal outlet 21.

In known manner, the illustrated TV system utilizes different carrier frequency bands for the transmission of different kinds of signals and signals in different directions between head end 11 and outlet boxes 18. Below, at is assumed that the system utilizes a first lower carrier frequency band b1, e.g. 15-65 MHz, for the transmission of message signals in the return direction, for instance for the transmission of data signals from data terminals 22, connected to outlets 21, to head end 11, while it utilizes a second higher carrier frequency band b2, e.g. 120-127 MHz, for the transmission of data signals in a forward direction, i.e. from head end 11 to data terminals 22, and two further carrier frequency bands b3 and b4, e.g. 88-108 MHz and 130-860 MHz, respectively, for the transmission of radio signals and TV signals from the head end to the subscribers.

In order to facilitate a reduction of the total noise within carrier frequency band b1, i.e. within the carrier frequency band serving for the transmission of message signals in the return direction, fed into network 12 from different branch lines 14 via the combined input and output 15, network 10 is provided with a special noise reduction unit 23, the more detailed structure of which will appear from FIG. 2.

Unit 23 comprises an input 24 which is connected to diplex filter 17 in order to receive signals within frequency band b1 incoming to said kilter from lines 14, and a line 25, having its one end connected to input 24 and containing a controllable blocking circuit 26. From line 25, those of the signals received at input 24, which are permitted to pass through blocking circuit 26, can be delivered to an output 27 of unit 23, connected to filter 17, in order then to pass further in the return direction to output 15 of network 10 via said filter and amplifier 16 and then to head end 11.

In FIG. 2, reference numerals 28, 29, 30 and 31 designate four band-pass filters which are connected to input 24 and have mutually different pass bands, located next to each other, and which serve to divide the signals incoming via input 24 on four subbands, together covering the entire frequency band b1. For this purpose, the different pass bands should be selected in such a manner that adjacent pass bands will overlap each other slightly. Furthermore, reference numerals 32, 33, 34 and 35 designate four detectors which are connected each to the output of one of said filters and which serve to compare the energy level of the output signal from the corresponding filter with at least one predetermined reference level and to deliver logic signals, depending upon the result of said comparison, to a logic control unit 36 for blocking circuit 26. For the purpose of generating and supplying one or more reference levels to the different detectors, there is provided a reference level generator 37.

Control unit 36 has for its purpose to determine whether the logic signals received by said unit satisfy certain conditions stored in said unit and to deliver a control signal to blocking circuit 26 for permitting a transmission of signals through said circuit from input 24 to output 27 only when the logic signals received by unit 36 satisfy the stored conditions.

The band width of band pass filters 32-35 may preferably be selected in such a manner that the energy level that can be expected to arise from, based on experience, normally appearing disturbances till be approximately equal within the different pass bands. This means that filters having lower pass band frequencies should normally have less band width than filters having higher pass band frequencies. If, as above mentioned, frequency band b1 is selected to cover 15-65 MHz, the pass bands of filters 32, 33, 34 and 35 may for instance be selected to cover 15-24 MHz, 24-34 MHz, 34-47 MHz and 47-65 MHz, respectively.

In order to make it possible, from head end 11, to effect an adjustment of the magnitude of the reference level or levels generated by means of generator 37, to reprogram control unit 36 in order to alter the conditions stored in said unit, or to bring about a temporary compulsory blocking or a temporary compulsory closing of the signal path through blocking circuit 26, there is provided a demodulator 38 to which control commands transmitted from head end 11 within frequency band b2 may be supplied via an input 39, connected to the junction line between amplifier 16 and diplex filter 17, and a band-pass filter 40 connected to said input.

The manner of operation of the noise reduction unit 23 above described may be summarized as follows. By means of the four filters 28-31, a signal within frequency band b1 incoming to the noise reduction unit via input 24 is divided into four different subbands. The portion of the signal that falls within a certain subband is supplied to the detector 32, 33, 34 or 35, respectively, connected to the filter in question. The detector compares the energy level of the incoming signal with at least one reference level and delivers a logic output signal depending upon said comparison to control unit 36. In said unit, the logic signals incoming from the different detectors are examined in order to ascertain whether they satisfy the stored conditions. A control signal for closing the signal path from input 24 to output 27 through blocking circuit 26 is supplied to said circuit from control unit 36 only at times when unit 36 receives logic signals satisfying the conditions stored in said unit. These conditions, which may be of any suitable type, may either be permanently stored in unit 36 or they may be reprogrammable from head end 11.

By comparing, in each detector, the energy level of the incoming signal from the corresponding filter with two different reference level, it is possible in an easy manner to facilitate a control of blocking circuit 26 from control unit 36 not only in dependence upon the energy level of the signals incoming to the detector but also in dependence upon the slope of said signals.

In line 25, a delay circuit 41 mall be connected in order, upon receipt of an acceptable input signal at input 24, to facilitate a certain compensation for the delay in the closing of the signal path through blocking circuit 26 caused by filters 28-31, detectors 32-35 and control unit 36.

In head end 11 of the system, means may be provided for measuring the noise level of incoming signals within carrier frequency band b1. Furthermore, the head end may also include means by which it is possible, upon a detection of an unacceptably high noise level, from the head end to transmit control commands on carrier frequency band b2 for successively compulsorily activating the blocking function of the blocking circuits 26 contained in different local networks. By designing the system in this manner, it is possible quickly to determine from which local network the high noise emanates and then to block said network and prevent any continued transmission of signals within carrier frequency band b1 therefrom until the cause of the unacceptable noise transmission has been eliminated.

The invention is not restricted to the embodiment above described and shown in the drawings. Instead, many other embodiments are feasible within the scope of the invention as defined in the following claims.

By way of example, it could be mentioned that the noise reduction unit may include two or more groups of band-pass filters with appurtenant detectors, in which case the different groups may cover different portions of carrier frequency band b1 and be arranged, via a logic control unit, each to control one blocking circuit belonging to the group in question. Moreover, in addition to one or more such groups, the noise reduction unit may also include one or more separate band-pass filters and detectors which are operatively connected each to one separate blocking means.

1. Local network (10), forming part of a cable TV system and being arranged to permit a transmission of signals in the return direction from subscriber outlets (21) included in said network (10) to a head end (11) of said system within a predetermined carrier frequency band, serving for the transmission of signals in said direction, said network being provided with a noise reduction unit (23) serving to reduce the amount of noise transmitted in the return direction from said network (10) and comprising an input (24) connected to the subscriber outlets (21), an output (27) connected to the head end (11), a plurality of band-pass filters (28-31) connected to said input (24) and having mutually different pass bands lying within said carrier frequency band, a corresponding plurality of detectors (32-35), which are connected each to one of said filters (28-31) and which are arranged each to compare the energy level of the output signal from the respective filter (28-31) with at least one predetermined reference level, and blocking means (26), operatively connected to said detectors (32-35) and arranged to permit or prevent a transmission of signals from said input (24) to said output (27) in dependence upon the result of the comparison effected by said detectors (32-35), characterized in that, for at least one group of adjacent pass bands, said blocking means are formed by a single blocking circuit (26) which is common to all pass bands within said group and connected in a separate line (25), serving for the transmission of signals within these pass bands from said input (24) to said output (27), and which is operatively connected to each of the detectors (32-35) belonging to said group of pass bands.

2. Local network according to claim 1, characterized in that said group includes all pass bands within said carrier frequency band.

3. Local network according to claim 1 or 2, characterized in that the detectors (32-35) belonging to said group of pass bands are arranged to deliver logic output signals depending upon the comparison effected by them to a logic control unit (36) which is arranged to determine whether these signals satisfy certain conditions stored in the control unit (36) and to deliver a control signal, depending hereupon, to the blocking circuit (26), in order hereby to bring this circuit to permit a transmission of signals from said input (24) to said output (27) only when said output signals from the detectors (32-35) satisfy said conditions.

4. Local network according to claim 3, characterized in that said conditions consist of conditions permanently stored in the control unit (36).

5. Local network according to claim 3, characterized in that the control unit (36) is reprogrammable and arranged to permit an alteration of the conditions stored therein.

6. Local network according to any of the preceding claims, characterized in that at least one of the detectors (32-35) belonging to said group of pass bands is arranged to compare the energy level of the output signal from the band-pass filter (28-31) connected thereto with at least two different reference levels.

7. Local network according to claim 6, characterized in that the control unit (36) is arranged to determine the slope of the front edge of the output signal from the band-pass filter (28-31) connected to said at least one detector (32-35) and to ascertain whether it satisfies a corresponding condition stored in the control unit (36).

8. Local network according to claim 7, characterized in that the control unit (36) is arranged to deliver a signal for permitting a signal transmission through the blocking circuit (26) only on the condition that the value of the determined slope falls within a predetermined permitted interval.

9. Local network according to any of the preceding claims, characterized in that said at least one reference level or each of said reference levels, respectively, is adjustable.

10. Local network according to any of the preceding claims, characterized in that it includes a delay means (41) provided in the connection (25) between the input (24) of the noise reduction unit (23) and the blocking circuit (26).
